(19) United States
(12) Patent Application Publication
(10) Pub. No.: US 2010/0236142 A1
(43) Pub. Date: Sep. 23, 2010

(54) PLANTING CONTAINER FOR THE DO-IT-YOURSELF MARKET

(76) Inventor: Michael S. Drewry, San Antonio, TX (US)

Correspondence Address: GUNN, LEE & CAVE, P.C., 300 CONVENT ST., SUITE 1080, SAN ANTONIO, TX, 78205, US

(21) Appl. No.: 12/719,485

(22) Filed: Mar. 8, 2010

Related U.S. Application Data
(60) Provisional application No. 61/161,324, filed on Mar. 18, 2009.

(51) Int. Cl. A01G 13/02; A01G 9/02

(52) U.S. Cl. 47/29.1; 47/79

(57) ABSTRACT

A home garden planter system is shown that can be assembled or disassembled for movement from one location to another. A frame with quick connecting corners is provided. A hose connects passages in a portion of the frame to a source of pressurized water. Opposite ends of the passages connect to irrigation devices for watering said soil within the frame. A translucent cover is supported above the frame. Also, a bed may be included that fits snuggly within the frame and holds the soil in which the plants will grow.

### CROSS-REFERENCES TO RELATED APPLICATIONS

The present invention claims benefit under 35 U.S.C. 119(e) of U.S. Provisional Application for Patent No. 61/161,324, filed Mar. 18, 2009.

### BACKGROUND OF THE INVENTION

1. Field of the Invention

The present invention relates to planting containers, more particularly, to planning containers for the do-it-yourself market.

2. Brief Description of the Prior Art

Previously, our society was predominately an agricultural based society. At that time, if someone wanted a particular type plant, it was planted outside in the soil and allowed to grow. As our society became more urban, there is less and less space in which to grow plants. As the space decreased, people started growing plants inside in containers. One of the problems of growing plants in containers is keeping the plants watered. Many times people forget to water the plants and the plants die. Also, if the pot does not have some type of drainage with a protective saucer-type container there below, water from the pot can drain onto the floor and cause damage to the floor.

On the outside, there is less and less room to grow plants by the typical homeowner. For example, the home may have very little yard or almost no top soil. In those circumstances, it is difficult to have plants growing in a yard or garden. One way this has been solved in the past is by having planting boxes arranged outside the home. However, the planting boxes have the problem of drying up when the homeowner forgets to water the plants and the plants die.

In South Texas where Applicant resides, deer have multiplied in quantities never before seen in this country. As a result, in urban neighborhoods, deer will eat almost anything a person attempts to grow unless something is done to keep the deer from getting to the plants. Depending on the area of the country, each area has different pests that have a tendency to eat plants that people want to grow. The present invention attempts to solve many of these problems.

### BRIEF DESCRIPTION OF THE DRAWINGS

FIG. 1 is an overhead view of the planting container with flow passages therein being shown in broken lines.

FIG. 2 is a side view of the planting container shown in FIG. 1 with a cage mounted thereon and flow passages and supporting ribs being shown in broken lines.

FIG. 3 is an end view of FIG. 2.

FIG. 4 is a prospective view of FIGS. 2 and 3.

FIG. 5 is a cross-sectional view of FIG. 2 taken along sections lines 5-5.

FIG. 6 is a partial, cross-sectional view of FIG. 5 taken along section line 6-6.

FIG. 7 is a partial, end view of FIG. 2 along line 7-7.

FIG. 8 is a prospective view of a connecting corner for the cage.

FIG. 9 are elevated views of male and female connectors.

FIG. 10 is a plant tag that may be held in place by a drip emitter.

FIG. 11 is a prospective view of a drip emitter.

FIG. 12 is a prospective view illustrating use of the planting containers in a garden-type environment.

### BRIEF DESCRIPTION OF THE PREFERRED EMBODIMENT

Referring first to FIG. 12 of the drawings, a planting container 20 is illustrated with cage 22 located thereabove. A hose 24 is connected to the planting cages 20 with intermediate hose lengths 26 being interconnected between various planting containers 20. The hose 24 and the intermediate hose lengths 26 delivers water to drip emitters (not shown in FIG. 12) that provides water that is delivered to soil contained inside of planting container 20. For the purposes of clarity, the soil is not shown in the planting container 20. Within the soil various plants may grow. The cages 22 prevent critters such as white-tailed deer from eating the plants.

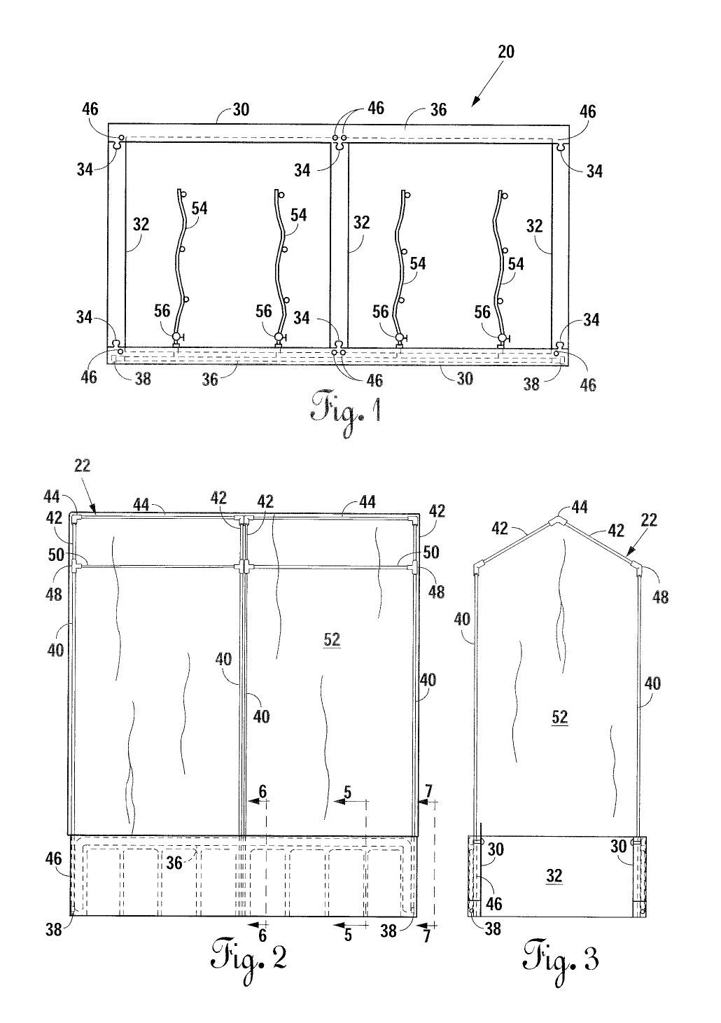

Referring now to FIG. 1, a top view of the planting container 20 is shown. The planting container 20 has side panels 30 on either side thereof. Cross panels 32 connect between the side panels 30. Tongue and groove joints 34 connects the side panels 30 to the cross panels 32.

Contained within the side panels 30 is a water passage 36 that has hose connectors 38 on either end thereof.

Referring to FIGS. 1 through 4 in combination, a cage 22 is shown above the planting container 20. The cage 22 has a support frame consisting of posts 40 with top braces 42 and ridge beam 44. The posts 40 are received into a hole 46 contained in the side panels 30 of the planting container 20.

While the top braces 42 are shown as sloped similar to a house, the top braces 42 could be horizontal and eliminate the ridge beam 44. The top braces 42 are connected to the post 40 with a corner connector 48 (see FIG. 8). Also connecting into the corner connector 48 is a horizontal brace 50 which is also shown in FIG. 2.

Overlying the skeletal frame formed by post 40, top braces 42, ridge beam 44 and horizontal brace 50 is screen panels 52. While the screen panels 52 may be of any particular material, it is envisioned that the screen panels 52 would be a sufficient size and spacing to prevent critters predominate in the area of the user from getting through screen panels 52 to the live plants 28. The screen panels 52 may be connected to the frame by any convenient means including quick ties (not shown).

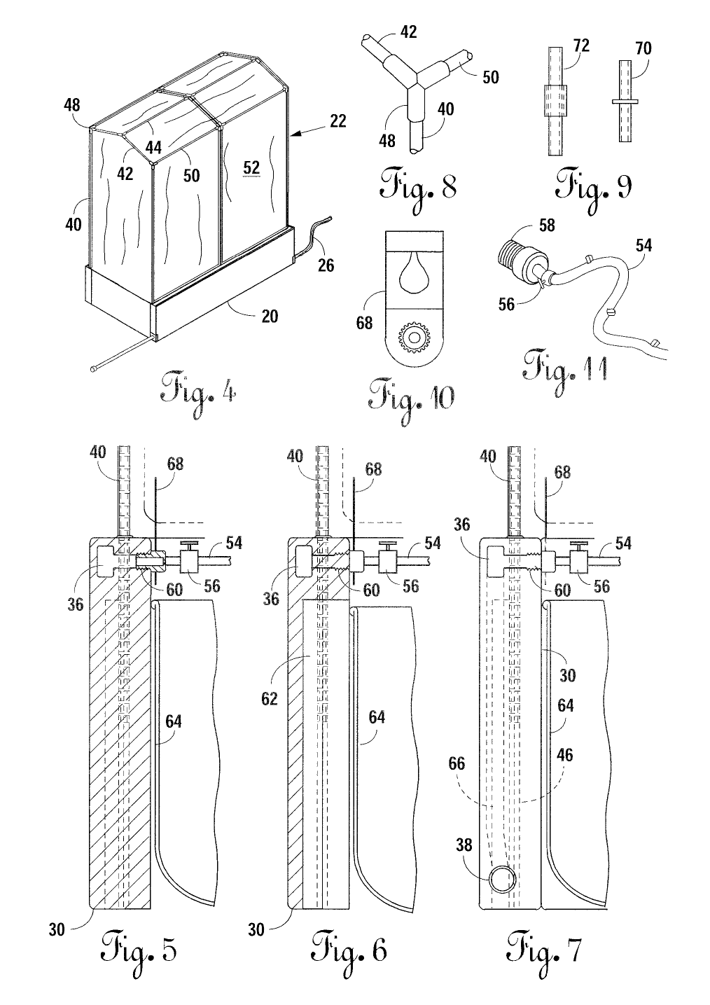

Referring now to FIG. 5 which is a partial, cross-sectional view of FIG. 2 along section lines 5-5, a cross-section of the side panel 30 is provided. The water passage 36 is in the top of the side panel 30 with a drip emitter 54 threadably connected therein (see FIG. 11). The amount of water flowing from the water passage 36 through the drip emitter 54 is controlled by adjusting the nut 56 on the drip emitter 54 (see FIG. 8). The threads 58 simply connect into the threaded passage 60 which connects to the water passage 36.

Referring now to FIG. 6 which is taken along section lines 6-6 of FIG. 2, a hollowed out portion 62 of the side panels 30 is illustrated. By having the hollowed out portion 62, less material is required. Also, if it is desirable to have the planning container 20 on a porch, inside of a house, or at any location other than on the ground, a soil retaining tub 64 may be included. The soil retaining tub 64 is large enough to fill each square section of the planting containers 20. Referring to FIG. 4, two identical soil retaining tubs 64 would be included. On the other hand, if the planting container 20 is to be used outside on the ground, it may not be necessary to use the soil retaining tub 64.

Referring now to FIG. 7, an end view of the side panel 30 is provided with the end view being along the direction of the lines 7-7 in FIG. 2. By looking at the end view of the side panel 30 as shown in FIG. 7, the location of the post 40 contained in hole 46 is clearly indicated. Also, the hose connector 38 connects through upward flow passage 66 to the water passage 36. From the water passage 36, drip emitters 54 are connected thereto.

If an individual has a series of planting containers 20, the individual may want to label the particular plant contained in each planting container 20. A plant tag 68 is illustrated in FIG. 10, which plant tag 68 can be connected behind the nut 56 of the drip emitter 54. An individual can then indicate on the plant tag 68 what type plant is in a particular planning container.

In putting together the frame, male connectors 70 or female connectors 72 may be necessary. The male connectors 70 and female connectors 72 can be used to extend any other frames such as post 40, top braces 42, ridge beam, 44 or horizontal brace 50.

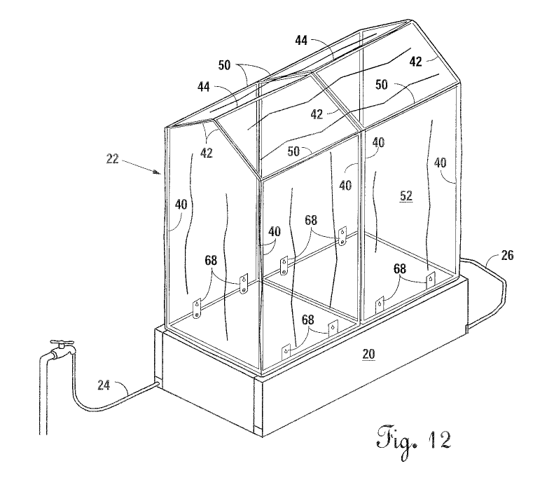

The entire planting container as shown in FIGS. 1 through 12 can be manufactured in unassembled form, and put together as a flat pack. For example, the side panels 30 disconnect from the cross panels 32 through the tongue and groove 34. Thereafter, they can be laid flat on each other. The cage 22 can be completely disassembled with the screen panels 52 removed, and the post 40, top brace 52, ridge beam 44, and horizontal 50 disconnected and laid flat. Everything can lay flat together and be shrink wrapped into a relatively small compact passage. Corner connectors 48, male connectors 70, and female connectors 72 as needed can be included. The drip emitters 54 may be preinstalled or installed by the end user. Intermediate hose lengths 26 as needed could also be included. The only thing that would occupy any appreciable volume would be the soil retaining tub 64 and they could be stackable, one inside the other, for buying multiple soil retaining tubs 64.

The do-it-yourselfer could go to one of the big box stores and buy multiple planting containers 20 with cages 22, and if also desired, the soil retaining tub 64. Simultaneously, the do-it-yourselfer could purchase potting soil as necessary. Upon taking the items home, the do-it-yourselfer could quickly assemble the planting containers 20, fill them with potting soil, and connect them together with the appropriated inner hose length 26 and hose 24 to have a self contained growing plot. After planting the plants to grow in the planting containers 20, the cages 22 can be assembled and installed. Thereafter, the plants desired by the do-it-yourselfer could be grown with very minimal effort while simultaneously protecting the plants from critters such as white-tailed deer.

I claim:

1. A home garden planter system for connecting to a source of pressurized water to irrigate retained soil for growing plants comprising:
a rectangular frame having quick connect corners, said rectangular frame having sufficient depth for said retained soil for growing plants, said rectangular frame having water flow passages through at least a portion thereof;
an input hose connecting between said source of pressurized water and a first end of said water flow passages in said rectangular frame;
irrigation hoses connecting to said water flow passages in said rectangular frame and extending over or in said retained soil to distribute water received from said water flow passages to said retained soil;
said source of pressurized water being turned ON or OFF as needed.

2. The home garden planter system as given in claim 1 further comprising a supporting structure connected to said rectangular frame and extending there above, said supporting structure supporting a translucent cover over said growing plants.

3. The home garden planter system as given in claim 2, wherein said supporting structure is detachable and collapsible for ease of movement or storage.

4. The home garden planter system as given in claim 3, wherein said rectangular frame is detachable and collapsible for ease of movement or storage.

5. The home garden planter system as given in claim 4 further comprising a bed filled within soil rectangular frame, said bed holding said retained soil for said growing plants.

6. The home garden planter system as given in claim 1, wherein said water flow passages has a connection to a second end of said water flow passages for allowing water flow there from to a series of home garden planter systems.

7. The home garden planter system as given in claim 6 further comprising a flow control device between each of said irrigation hoses and said water flow passages.

8. The home garden planter system as given in claim 7, wherein said irrigation hoses are drip hoses.
